(19) United States
(12) Patent Application Publication
(10) Pub. No.: US 2025/0271073 A1
(43) Pub. Date: Aug. 28, 2025

(54) ASSEMBLY STRUCTURE OF VALVE SEAT

(71) Applicant: INZICONTROLS CO., LTD., Siheung-si (KR)

(72) Inventors: Jun Ho JANG, Siheung-si (KR); Hyun Kwon Lee, Siheung-si (KR); Hyeong Cheon Seo, Siheung-si (KR); Shin Woong Kim, Siheung-si (KR); Si Kyung Seong, Siheung-si (KR)

(73) Assignee: INZICONTROLS CO., LTD., Siheung-si (KR)

(21) Appl. No.: 18/983,662

(22) Filed: Dec. 17, 2024

(30) Foreign Application Priority Data
Feb. 28, 2024 (KR) 10-2024-0028959
Nov. 6, 2024 (KR) 10-2024-0156423

(51) Int. Cl. F16K 25/00; F16K 11/085

(52) U.S. Cl. CPC F16K 25/00; F16K 11/0853

(57) ABSTRACT

Disclosed is a valve seat assembly structure capable of simply assembling a valve seat to a valve housing, including an inner wall and a single pair of first fastening portions having a shape that protrudes from the inner wall and provided to face each other; and a valve seat provided between the single pair of first fastening portions and including a second fastening portion formed on the side to couple with the first fastening portion, and each of the first fastening portion and the second fastening portion include an insertion shaped portion having a curved shape and a stopper shaped portion having a planar shape.

### CROSS-REFERENCE TO RELATED APPLICATION(S)

This application claims priority from and the benefit of Korean Patent Application No. 10-2024-0028959 filed on Feb. 28, 2024, and Korean Patent Application No. 10-2024-0156423 filed on Nov. 6, 2024, the entire disclosure of which is incorporated herein by reference for all purposes.

### BACKGROUND

### 1. Field

Example embodiments relate to an assembly structure of a valve seat, and more particularly, to a valve seat assembly structure that allows a valve seat to be easily assembled to a valve housing.

### 2. Related Art

In general, a valve is formed in a system that guides a flow direction of fluid. The valve is rotatably accommodated in an inner space of a valve housing. Here, a valve seat is provided between the valve housing and the valve.

### SUMMARY

Example embodiments propose a structure that may stably assembly a valve seat to a valve housing.

According to an example embodiment, there is provided a valve seat assembly structure including a valve housing including an inner wall and a single pair of first fastening portions having a shape that protrudes from the inner wall and provided to face each other; and a valve seat provided between the single pair of first fastening portions and including a second fastening portion formed on the side to couple with the first fastening portion, wherein each of the first fastening portion and the second fastening portion includes an insertion shaped portion having a curved shape and a stopper shaped portion having a planar shape.

According to an aspect, the first fastening portion may include a (1-1)-th insertion shaped portion that vertically extends in the vertical direction of the valve housing; and a (1-1)-th stopper shaped portion that is formed in the inner direction of the first fastening portion at the end of the largest horizontal cross-section of the (1-1)-th insertion shaped portion.

According to an aspect, the first fastening portion may include a (1-2)-th insertion shaped portion that extends in a curved shape from the lower side of the (1-1)-th insertion shaped portion; and a (1-2)-th stopper shaped portion that extends in the inner direction of the first fastening portion at the end of the largest horizontal cross-section of the (1-2)-th insertion shaped portion.

According to an aspect, the second fastening portion may include a (2-1)-th insertion shaped portion that is formed in a straight area on the side of the valve seat, and vertically extends in the vertical direction of the valve seat; and a (2-1)-th stopper shaped portion that is formed in the inner direction of the second fastening portion at the end of the largest horizontal cross-section of the (2-1)-th insertion shaped portion.

According to an aspect, the second fastening portion may include a (2-2)-th insertion shaped portion that is formed in a curved area on the side of the valve seat and extends in a curved shape from the lower side of the (2-1)-th insertion shaped portion; and a (2-2)-th stopper shaped portion that extends in the inner direction of the second fastening portion at the end of the largest horizontal cross-section of the (2-1)-th insertion shaped portion.

According to an aspect, the valve seat may be curved on both left and right sides to have a constant curvature based on a vertical centerline.

According to an aspect, the valve seat may include a first wall portion formed on its outside; and a second wall portion formed to surround a center hole of the valve seat, and an insertion groove may be formed between the first wall portion and the second wall portion.

According to an aspect, a sealing portion may insert into the insertion groove.

According to an aspect, the sealing portion may be an X-ring or an O-ring.

According to an example embodiment, there is provided a valve seat assembly structure including a valve housing including an inner wall and a single pair of first fastening portions having a shape that protrudes from the inner wall and provided to face each other; a valve seat formed with an insertion groove, provided between the single pair of first fastening portions, and having a second fastening portion to couple with the first fastening portion; and a sealing portion configured to insert into the insertion groove, wherein the valve seat includes a closed portion, a first wall portion formed on the outside based on the insertion groove, and a second wall portion formed on the inner side than the first wall portion, a chamfer portion obliquely provided to face the first fastening portion is formed in a portion in which an outer portion of the closed portion and an outer portion of the first wall portion are connected to each other, and a round portion having a first curvature is formed in a portion in which the outer portion of the closed portion and an outer portion of the second wall portion are connected to each other.

According to example embodiments, a valve seat may be easily assembled to a valve housing using a snap-fit method.

Also, according to example embodiments, when assembling a valve seat, a sealing portion accommodated in the valve seat may be stably and closely adhered to a valve housing.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Embodiments will be described in more detail with regard to the figures, wherein like reference numerals refer to like parts throughout the various figures unless otherwise specified, and wherein:

FIG. 1 illustrates a state in which a valve seat is mounted to a valve housing according to an example embodiment;

FIG. 2 illustrates a state in which a valve seat is partially separated from a valve housing according to an example embodiment;

FIG. 3 is a view cut along line A-A′ of FIG. 2;

FIG. 4 is an enlarged plan view of a portion X of FIG. 2;

FIG. 5 is a front view of a valve seat according to an example embodiment;

FIG. 6 is a rear view of a valve seat according to an example embodiment;

FIG. 7 is a top view of a valve seat according to an example embodiment;

FIG. 8 illustrates a state in which a sealing portion is separated from a valve seat according to an example embodiment;

FIG. 9 illustrates a state in which a valve seat is mounted to a valve housing according to another example embodiment;

FIG. 10 illustrates a state in which a valve seat is partially separated from a valve housing according to another example embodiment;

FIG. 11 is an enlarged view of a portion Y of FIG. 10;

FIG. 12 is an enlarged view of a portion Z of FIG. 10;

FIG. 13 is a front view of a valve seat according to another example embodiment;

FIG. 14 is a rear view of a valve seat according to another example embodiment;

FIG. 15 is a view cut along line C-C′ of FIG. 13;

FIG. 16 illustrates a state in which a sealing portion is separated from a valve seat according to another example embodiment; and

FIG. 17 is a view cut along line B-B′ of FIG. 10.

### DETAILED DESCRIPTION

Hereinafter, an assembly structure of a valve seat according to an example embodiment is described with reference to the accompanying drawings. Here, like reference numerals refer to like elements throughout, and repetitive description and detailed description related to known functions and configurations that may unnecessarily obscure the gist of the invention are omitted. Implementation of the invention is provided to more fully explain the present invention for one of ordinary skill in the art. Therefore, shapes and sizes of elements in the drawings may be exaggerated for more clear explanation.

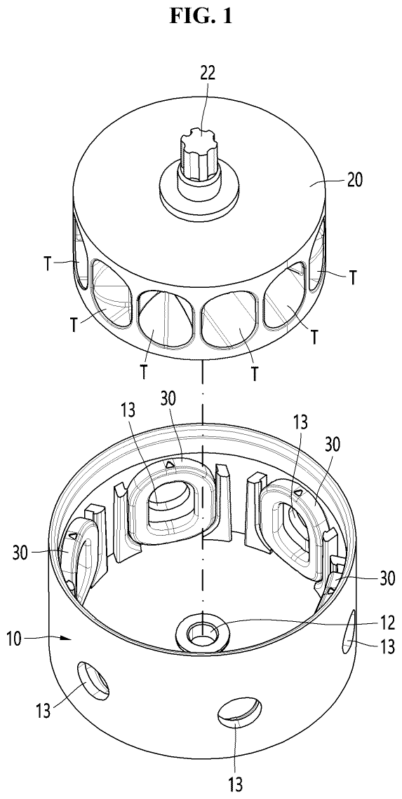

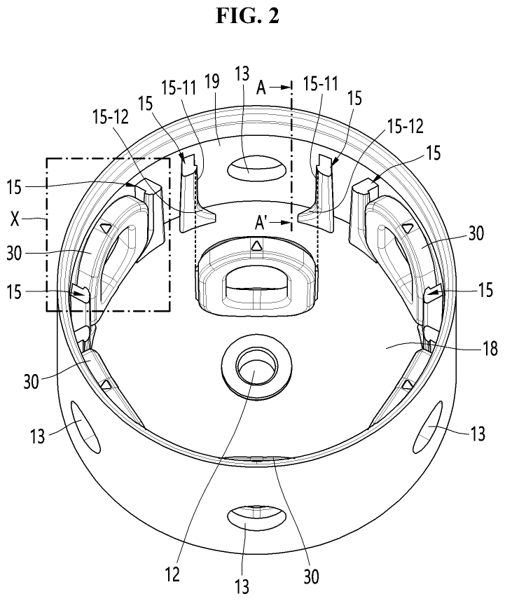

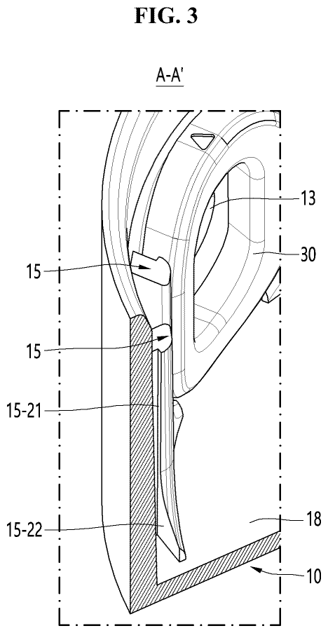

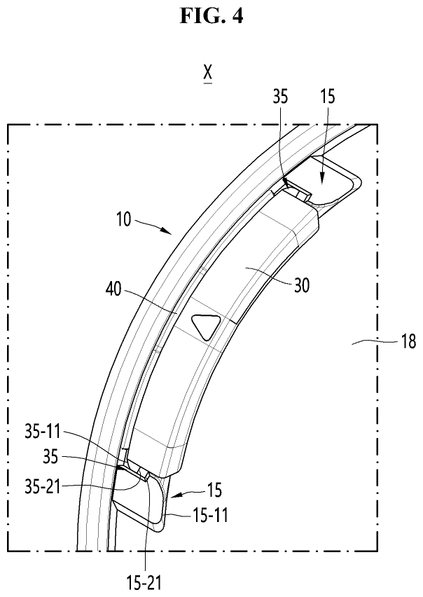

FIG. 1 illustrates a state in which a valve seat is mounted to a valve housing according to an example embodiment, FIG. 2 illustrates a state in which a valve seat is partially separated from a valve housing according to an example embodiment, FIG. 3 is a view cut along line A-A′ of FIG. 2, and FIG. 4 is an enlarged plan view of a portion X of FIG. 2.

Referring to FIG. 1, a valve seat assembly structure according to an example embodiment relates to a structure in which a valve seat 30 is assembled to a valve housing 10.

The valve housing 10 may have an internal space such that the valve 20 may be rotatably accommodated. Here, the valve 20 may have a substantially cylindrical shape and may include a plurality of flow paths (T). A shaft 22 may be formed in the valve 20. The shaft 22 may be formed in the vertical direction at the center of the valve 20, and may have both ends that protrude outward along the vertical direction of the valve 20. One end of the shaft 22 may be connected to an actuator (not shown) such that the valve 20 may rotate and another end of the shaft 22 may insert into an inserting portion 12 formed in a bottom 18 of the valve housing 10.

A connecting hole 13 connectable to a port may be formed in an inner wall 19 of the valve housing 10. A plurality of connecting holes 13 may be formed in the inner wall 19 of the valve housing 10 along the circumferential direction thereof. The flow path (T) formed in the valve 20 may be in communication with the connecting hole 13. The valve seat 30 may be formed around the connecting hole 13 such that the valve 20 may be safely received. A detailed shape of the valve seat 30 is described below.

Referring to FIGS. 2 to 4, the valve housing 10 may include a first fastening portion 15 such that the valve seat 30 may be fastened. The first fastening portion 15 may have a shape that protrudes from the inner wall 19 of the valve housing 10 toward the center of the valve housing 10, and may be formed to extend along the vertical direction of the valve housing 10. The first fastening portions 15 may be formed at a certain distance on both sides of the valve seat 30 to face each other. Here, two first fastening portions 15 formed to face each other may constitute a single pair. A plurality of pairs of such first fastening portions 15 may be formed on the inner wall 19 of the valve housing 10 along the circumferential direction thereof.

The first fastening portion 15 may include a first insertion shaped portion 15-11, 15-12 and a first stopper shaped portion 15-21, 15-22. The first insertion shaped portion 15-11, 15-12 may have a shape that helps the valve seat 30 insert into the first fastening portion 15, and the first stopper shaped portion 15-21, 15-22 may have a shape that helps the valve seat 30 insert into first fastening portion 15 and be stopped.

The first insertion shaped portion 15-11, 15-12 may have an outer surface formed in the direction toward the inside of the valve housing 10, and the first stopper shaped portion 15-21, 15-22 may have an outer surface formed in a direction toward the inner wall 19 of the valve housing 10.

In detail, referring to FIG. 2, the first insertion shaped portion 15-11, 15-12 may include a curved shape based on a horizontal cross-section of the first fastening portion 15, and may have a shape of which horizontal cross-sectional area gradually increases with getting closer to the inner wall 19 of the valve housing 10. The curved shapes of the first insertion shaped portions 15-11, 15-12 constituting a single pair may be formed to face each other. The first stopper shaped portion 15-21, 15-22 may include a planar shape that extends from one end of the first insertion shaped portion 15-11, 15-12 in the inner direction of the first fastening portion 15.

The first insertion shaped portion 15-11, 15-12 may include the (1-1)-th insertion shaped portion 15-11 that vertically extends in the vertical direction and the (1-2)-th insertion shaped portion 15-12 that extends in a curved shape from the lower end of the (1-1)-th insertion shaped portion 15-11 when the first fastening portion 15 is viewed from the front. The first stopper shaped portion 15-21, 15-22 may include the (1-1)-th stopper shaped portion 15-21 that vertically extends in the vertical direction and the (1-2)-th stopper shaped portion 15-22 that extends in a curved shape from the lower end of the (1-1)-th stopper shaped portion 15-21 when the first fastening portion 15 is viewed from the front. Here, the (1-2)-th insertion shaped portion 15-12 and the (1-2)-th stopper shaped portion 15-22 present on both sides based on the valve seat 30 may have the curved shapes that approach each other.

Based on a direction from the center of the valve housing 10 toward the inner wall 19, a distance between a single pair of first insertion shaped portions 15-11, 15-12 that face each other may gradually decrease and a distance between the first fastening portions 15 may increase again from the first stopper shaped portion 15-21, 15-22.

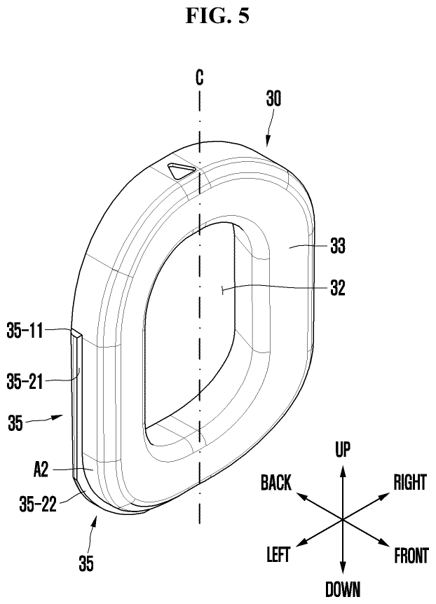

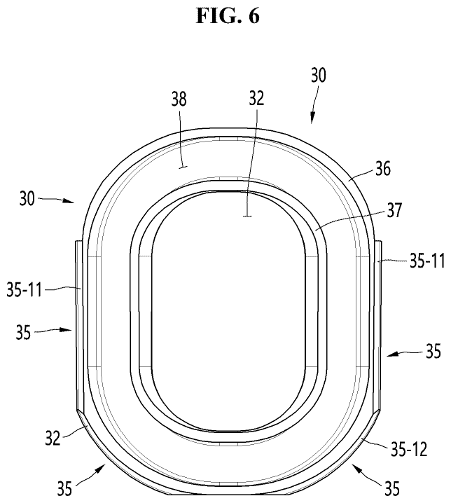

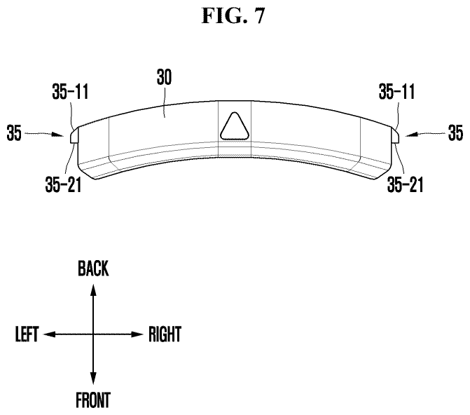

FIG. 5 is a front view of a valve seat according to an example embodiment, FIG. 6 is a rear view of a valve seat according to an example embodiment, and FIG. 7 is a top view of a valve seat according to an example embodiment.

Referring to FIGS. 5 to 7, the valve seat 30 may have a ring shape that surrounds a center hole 32. As shown in FIG. 5, in an example embodiment, the valve seat 30 may include a first area (A1) and a second area (A2). The first area (A1) may be a straight area formed on each of both left and right sides of the valve seat 30, and the second area (A2) may be a curved area that extends upward or downward from each of both left and right sides of the valve seat 30.

As shown in FIG. 5, a contact portion 33 that may contact the valve 20 may be formed in the valve seat 30. Here, the valve seat 30 may be formed to have a certain curvature to contact the outer peripheral surface of the valve 20. Referring to FIGS. 5 and 7, the valve seat 30 may be formed to be curved on both left and right sides with respect to a centerline (C). Here, the curved curvature of the valve seat 30 and the curvature of the outer peripheral surface of the valve 20 may be formed to be identical or similar to each other.

As shown in FIG. 6, the valve seat 30 may include a first wall portion 36 and a second wall portion 37. The first wall portion 36 may be formed on the outer end of the valve seat 30, and the second wall portion 37 may be formed inside the valve seat 30 at a certain distance from the first wall portion 36. The first wall portion 36 may form the outer surface of the valve seat 30, and the second wall portion 36 may be formed to surround the center hole 32.

An insertion groove 38 may be formed between the first wall portion 36 and the second wall portion 37. The insertion groove 38 may have a ring shape along the first wall portion 36 and the second wall portion 37. The upper side of the insertion groove 38 may be open and the opposite side of its bottom may be the contact portion 33 described above.

A second fastening portion 35 may be formed on each of both left and right sides of the valve seat 30. The second fastening portion 35 may have a shape that protrudes outward from each of both left and right sides of the valve seat 30, and may be formed to extend along the outer surface of the valve seat 30 in the vertical direction of the valve seat 30.

The second fastening portion 35 may include a second insertion shaped portion 35-11, 35-12 and a second stopper shaped portion 35-21, 35-22.

The second insertion shaped portion 35-11, 35-12 may have the outer surface formed toward the rear of the valve seat 30, and the second stopper shaped portion 35-21, 35-22 may have the outer surface formed toward the front of the valve seat 30.

In detail, referring to FIGS. 5 to 7, the second insertion shaped portion 35-11, 35-12 may include a curved shape based on a horizontal cross-section of the second fastening portion 35, and may have a shape of which the horizontal cross-section gradually increases with getting closer from the rear to the front of the valve seat 30. The second stopper shaped portion 35-21, 35-22 may include a planar shape that extends from one end of the second insertion shaped portion 35-11, 35-12 in the inner direction of the second fastening portion 35.

The second insertion shaped portion 35-11, 35-12 may include the (2-1)-th insertion shaped portion 35-11 that vertically extends in the vertical direction and the (2-2)-th insertion shaped portion 35-12 that extends in a curved shape from the lower end of the (2-1)-th insertion shaped portion 35-11 when the second fastening portion 35 is viewed from the front. The second stopper shaped portion 35-21, 35-22 may include the (2-1)-th stopper shaped portion 35-21 that vertically extends in the vertical direction and the (2-2)-th stopper shaped portion 35-22 that extends in a curved shape from the lower end of the (2-1)-th stopper shaped portion 35-21 when the second fastening portion 35 is viewed from the front.

The (2-1)-th insertion shaped portion 35-11 and the (2-1)-th stopper shaped portion 35-21 may be formed in the first area (A1) of the valve seat 30, and the (2-2)-th insertion shaped portion 35-12 and the (2-2)-th stopper shaped portion 35-22 may be formed in the second area (A2) that is formed on the lower side of the valve seat 30.

The (2-1)-th insertion shaped portion 35-11 and the (2-1)-th stopper shaped portion 35-21 may correspond to the (1-1)-th insertion shaped portion 15-11 and the (1-1)-th stopper shaped portion 15-21 of the first fastening portion 15, respectively, and the (2-2)-th insertion shaped portion 35-12 and the (2-2)-th stopper shaped portion 35-22 may correspond to the (1-2)-th insertion shaped portion 15-12 and the (1-2)-th stopper shaped portion 15-22 of the first fastening portion 15, respectively. Here, when the first fastening portion 15 and the second fastening portion 35 are viewed from the front, the curvature of the curved shape of the (2-2)-th insertion shaped portion 35-12 and the (2-2)-th stopper shaped portion 35-22 may be formed to be identical or similar to the curvature of the curved shape of the (1-2)-th insertion shaped portion 15-12 and the (1-2)-th stopper shaped portion 15-22 of the first fastening portion 15.

Meanwhile, a distance between portions that protrude most from both left and right sides of the valve seat 30 in the second insertion shaped portion 35-11, 35-12 may be greater than a distance between portions that are formed to face each other and protrude most from both left and right sides in the first insertion shaped portion 15-11, 15-12 among the pair of first fastening portions 15.

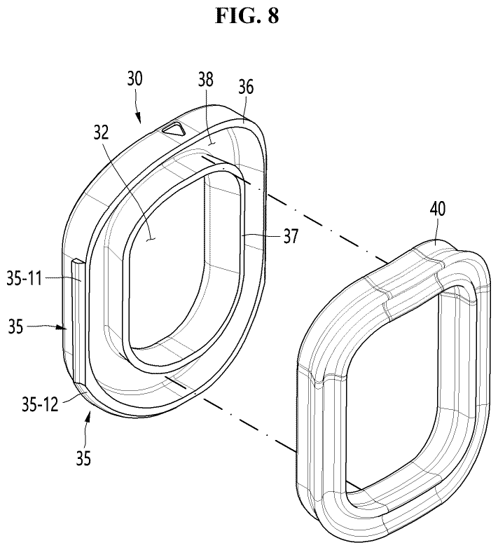

FIG. 8 illustrates a state in which a sealing portion is separated from a valve seat according to an example embodiment.

Referring to FIG. 8, in an example embodiment, a sealing portion 40 may insert into the insertion groove 38 of the valve seat 30. The sealing portion 40 may be formed of a rubber material. The sealing portion 40 may have a ring shape. For example, the sealing portion 40 may have a shape of X-ring and O-ring.

According to an example embodiment, while the first fastening portion 15 of the valve seat 30 and the second fastening portion 35 of the valve seat 30 couple with each other, the valve seat 30 may be fastened to the valve housing 10 using a snap-fit method.

Referring to FIGS. 2 to 4, when the valve seat 30 is provided to be assembled on the inner wall 19 of the valve housing 10, the first insertion shaped portion 15-11, 15-12 of the first fastening portion 15 and the second insertion shaped portion 35-11, 35-12 of the second fastening portion 35 may be provided to have the curved shape in opposite directions. The second insertion shaped portion 35-11, 35-12 may move along the outer surface of the first insertion shaped portion 15-11, 15-12. Here, the first fastening portion 15 may be elastically deformed to increase the distance between a single pair of first fastening portions 15 or the second fastening portion 35 may be elastically deformed to decrease the distance between the second fastening portions 35 formed on left and right sides. When the end of the second insertion shaped portion 35-11, 35-12 reaches the end of the first insertion shaped portion 15-11, 15-12 (e.g., end with a largest area in the horizontal cross-section) and moves further, the second fastening portion 35 may be located on the inner side between the first fastening portions 15 and the first fastening portion 15 or the second fastening portion 35 may be elastically restored. Here, when the first stopper shaped portion 15-21, 15-22 and the second stopper shaped portion 35-21, 35-22 are provided to face each other and move in a direction opposite to an insertion direction of the valve seat 30, the valve seat 30 may be fastened to a single pair of first fastening portions 15 as the first stopper shaped portion 15-21, 15-22 and the second stopper shaped portion 35-21, 35-22 come into contact with each other.

Meanwhile, only the (1-1)-th insertion shaped portion 15-11 and the (1-1)-th stopper shaped portion 15-21 may be formed in the first fastening portion 15, and the (1-2)-th insertion shaped portion 15-12 and the (1-2)-th stopper shaped portion 15-22 may not be formed in the first fastening portion 15.

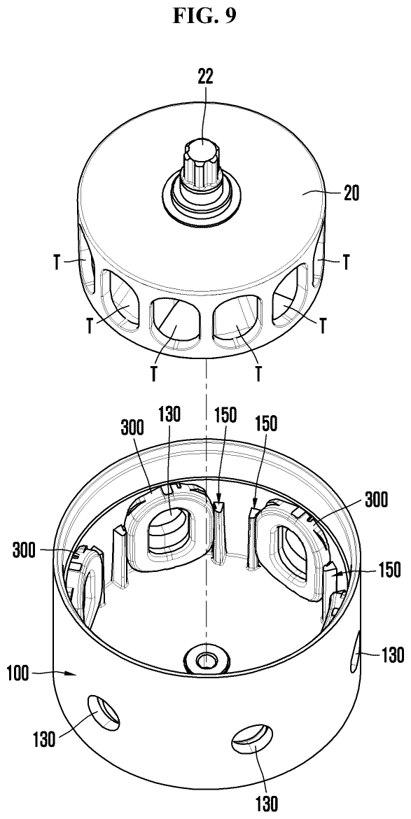

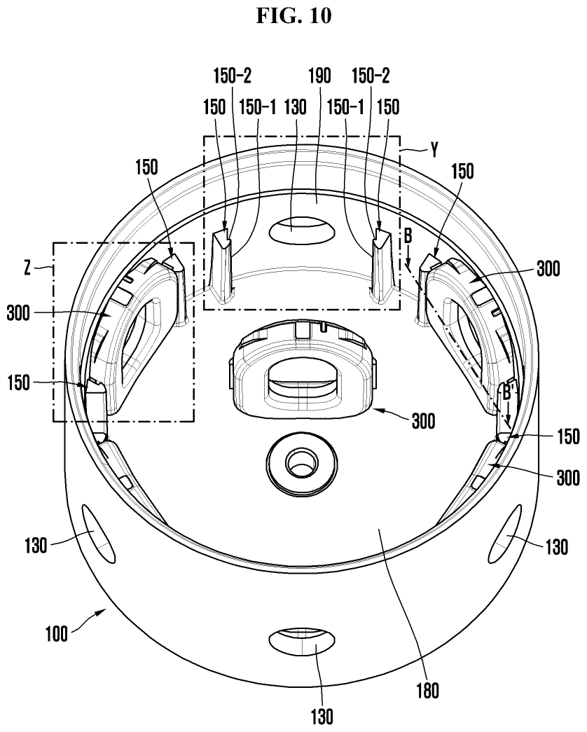

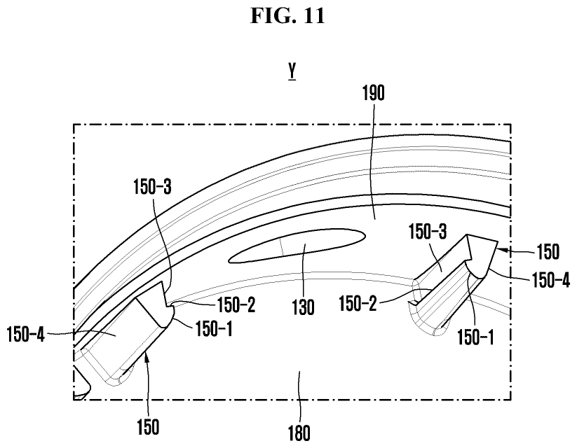

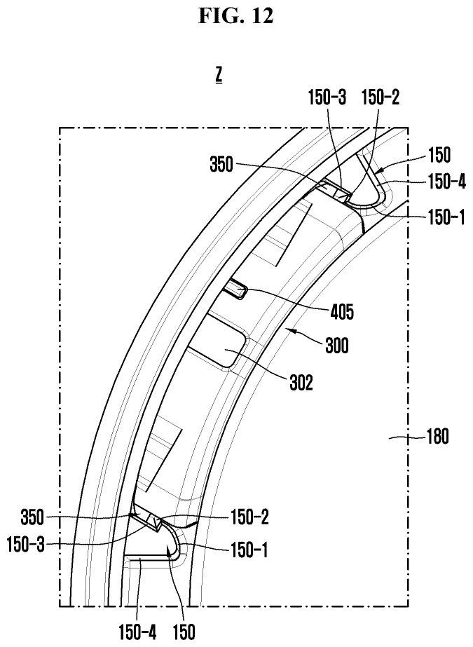

FIG. 9 illustrates a state in which a valve seat is mounted to a valve housing according to another example embodiment, FIG. 10 illustrates a state in which a valve seat is partially separated from a valve housing according to another example embodiment, FIG. 11 is an enlarged view of a portion Y of FIG. 10, and FIG. 12 is an enlarged view of a portion Z of FIG. 10.

Referring to FIG. 9, a valve seat assembly structure according to another example embodiment relates to a structure in which a valve seat 300 is assembled to a valve housing 100.

Meanwhile, in the valve seat assembly structure according to another example embodiment, description related to the valve 20, a connecting hole 130 formed in an inner wall 190 of the valve housing 100, and an inserting portion 120 formed in a bottom 130 may refer to description made above in the valve seat assembly structure according to an example embodiment.

Referring to FIGS. 10 to 12, the valve housing 100 may include a first fastening portion 150 such that the valve seat 300 may be fastened. The first fastening portion 150 may have a shape that protrudes from the inner wall 190 of the valve housing 100 toward the center of the valve housing 100, and may be formed to extend along the vertical direction of the valve housing 100. The first fastening portions 150 may be formed at a certain distance on both sides of the valve seat 300 to face each other. Here, two first fastening portions 150 formed to face each other may constitute a single pair. A plurality of pairs of such first fastening portions 150 may be formed on the inner wall 190 of the valve housing 100 along the circumferential direction thereof.

The first fastening portion 150 may include a first insertion shaped portion 150-1 and a first stopper shaped portion 150-2. The first insertion shaped portion 150-1 may have a shape that helps the valve seat 300 insert into the first fastening portion 150, and the first stopper shaped portion 150-2 may have a shape that helps the valve seat 300 insert into the first fastening portion 150 and be stopped.

The first insertion shaped portion 150-1 may have an outer surface formed in a direction toward the inside of the valve housing 100, and the first stopper shaped portion 150-2 may have a shape formed in a direction toward the inner wall 190 of the valve housing 100.

In detail, the first insertion shaped portion 150-1 may have a curved shape based on a horizontal cross-section of the first fastening portion 150, and may have a shape of which horizontal cross-sectional area gradually increases with getting closers to the inner wall 190 of the valve housing 100. The curved shapes of the first insertion shaped portions 150-1 constituting a single pair may be formed to face each other. The first stopper shaped portion 150-2 may include a planar shape that extends from one end of the first insertion shaped portion 150-1 in the inner direction of the first fastening portion 150.

The first insertion shaped portion 150-1 may have a shape that extends along the vertical direction. The first insertion shaped portion 150-1 may have a shape that extends such that its upper end and lower end have the identical or similar horizontal cross-section, or extends such that the horizontal cross-section gradually increases with getting closer from the upper side to the lower side.

Based on a direction from the center of the valve housing 100 toward the inner wall 190, a distance between a single pair of first insertion shaped portions 150-1 that face each other may gradually decrease and a distance between the first fastening portions 150 may increase again from the first stopper shaped portion 150-2.

Referring to FIG. 11, the first fastening portion 150 may include a first face 150-3 that extends from another end of the first stopper shaped portion 150-2 toward the inner wall 190 of the valve housing 100 and a second face 150-4 that extends from a protruding end of the first insertion shaped portion 150-1 toward the inner wall 190 of the valve housing 100. A distance between the first face 150-3 and the second face 150-4 may be formed to be farther away from each other based on a direction toward the inner wall 190 of the valve housing 100. When a single pair of first fastening portions 150 that face each other are viewed from above, the first faces 150-3 may be formed in a parallel posture with respect to each other, and the second faces 150-4 may be formed in a radial posture based on the center of valve housing 100.

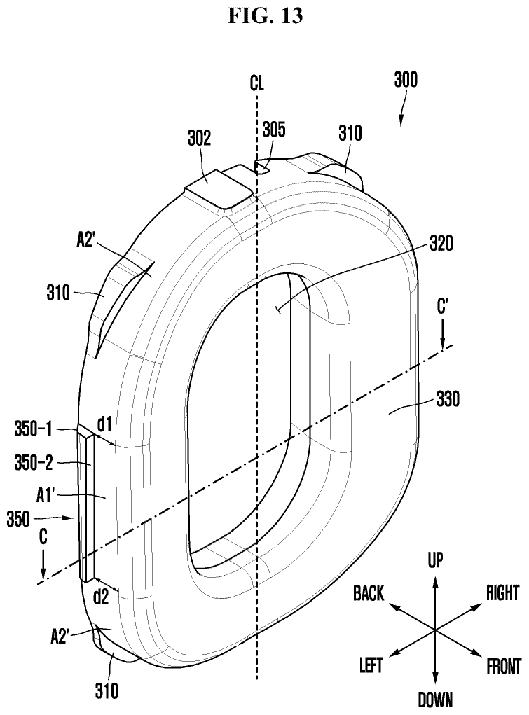

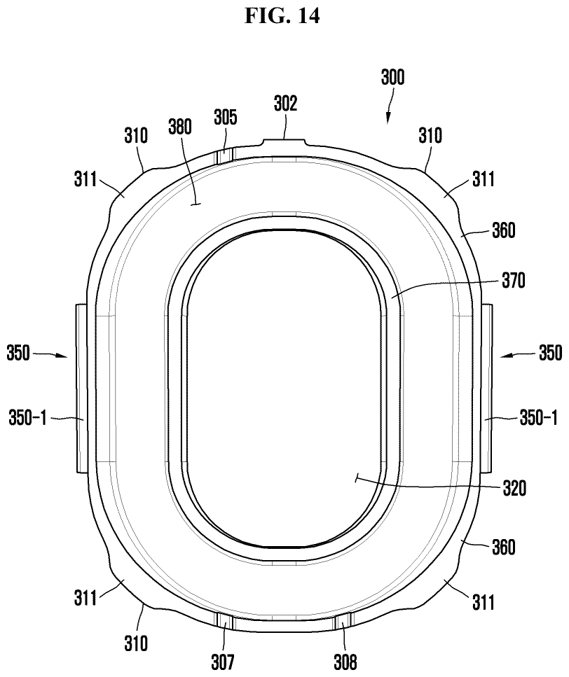

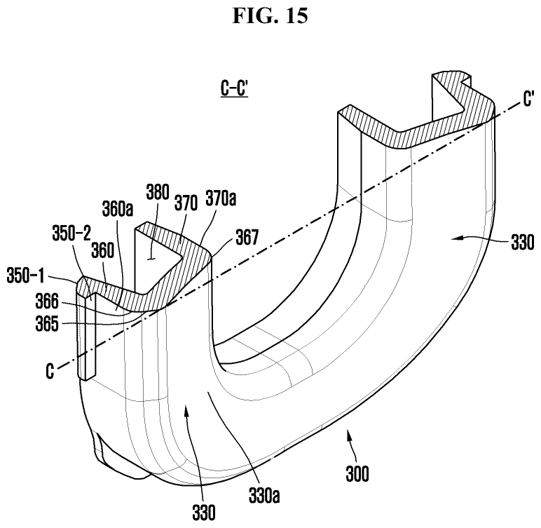

FIG. 13 is a front view of a valve seat according to another example embodiment, FIG. 14 is a rear view of a valve seat according to another example embodiment, and FIG. 15 is a view cut along line C-C′ of FIG. 13.

Referring to FIGS. 13 to 15, the valve seat 300 may have a ring shape that surrounds the center hole 320. The valve seat 300 according to another example embodiment may include a first area (A1′) and a second area (A2′). The first area (A1′) may be a straight area formed on each of both left and right sides of the valve seat 300, and the second area (A2′) may be a curved area that extends upward or downward from each of both left and right sides of the valve seat 300.

As shown in FIG. 13, a contact portion 330 that may contact the valve 20 may be formed in the valve seat 300. The contact portion 330 may be a closed surface or a closed portion of the valve seat 300. Here, the valve seat 300 may be formed to have a certain curvature to contact the outer peripheral surface of the valve 20. Referring to FIGS. 13 and 15, the valve seat 300 may be formed to be curved on both left and right sides with respect to a centerline (CL). Here, the curved curvature of the valve seat 300 and the curvature of the outer peripheral surface of the valve 20 may be formed to be identical or similar to each other.

A location indicator 302 may be formed on the top surface of the valve seat 300. There is no restriction on the shape of the location indicator 302. The valve seat 300 may be assembled to the valve housing 100 in a state in which the location indicator 302 is present on the upper side. That is, the location indicator 302 may prevent the valve seat 300 from being reverse-assembled to the valve housing 100.

Referring to FIG. 14, the valve seat 300 may include a first wall portion 360 and a second wall portion 370. The first wall portion 360 and the second wall portion 370 may be formed to extend toward the rear of the valve seat 300. The first wall portion 360 may be formed on the outer end of the valve seat 300, and the second wall portion 370 may be formed inside the valve seat 300 at a certain distance from the first wall portion 360. The first wall portion 360 may form the outer surface of the valve seat 300, and the second wall portion 360 may be formed to surround the center hole 320.

An insertion groove 380 may be formed between the first wall portion 360 and the second wall portion 370. The insertion groove 380 may have a ring shape along the first wall portion 360 and the second wall portion 370. The upper side of the insertion groove 380 may be open and the opposite side of its bottom may be the contact portion 330.

A first groove 305 may be formed on the upper side of the valve seat 300, and second grooves 307 and 308 may be formed on the lower side of the valve seat 300. The first groove 305 and the second grooves 307 and 308 may be formed to extend along the front from the rear of the first wall portion 360 of the valve seat 300. The number of first grooves 305 and the number of second grooves 307 and 308 may differ from each other. In another example embodiment, a single first groove 305 may be formed and the second grooves 307 and 308 may be formed in two spaced apart from each other by a certain distance. However, there is no restriction on the number of first grooves 305 and the number of second grooves 307 and 308.

A second fastening portion 350 may be formed on each of both left and right sides of the valve seat 300. The second fastening portion 350 may be formed to extend along the vertical direction. The second fastening portion 350 may be formed in the first area (A1′) of the valve seat 300.

The second fastening portion 350 may include a second insertion shaped portion 350-1 and a second stopper shaped portion 350-2. Description related to the shape of the second insertion shaped portion 350-1 and the second stopper shaped portion 350-2 may refer to contents described above in relation to the second insertion shaped portion 35-11 and the second stopper shaped portion 35-21 according to an example embodiment.

The second insertion shaped portion 350-1 and the second stopper shaped portion 350-2 may have the upper end surface and the lower end surface. Unlike an example embodiment, the lower end of the second insertion shaped portion 350-1 and the second stopper shaped portion 350-2 according to another example embodiment does not extend to the second area (A2′).

Referring to FIG. 13, the second stopper shaped portion 350-2 may have an inclined shape such that its one surface approaches the rear with getting closer from the upper side to the lower side. Viewing the side of the valve seat 300, a distance (d1) from the upper side of the second stopper shaped portion 350-2 to the front may be less than a distance from the lower side of the second stopper shaped portion 350-2 to the front.

The second insertion shaped portion 350-1 and the second stopper shaped portion 350-2 may correspond to the aforementioned first insertion shaped portion 150-1 and first stopper shaped portion 150-2 of the first fastening portion 150, respectively. Relationship between the second insertion shaped portion 350-1 and the second stopper shaped portion 350-2 and the first insertion shaped portion 150-1 and the first stopper shaped portion 150-2 of the first fastening portion 150 may refer to contents described in an example embodiment.

Meanwhile, the valve seat 300 according to another example embodiment may be manufactured using an injection method. Here, a pushing pin portion 310 through which an ejector pin operates may be formed in the valve seat 300. The pushing pin portion 310 may have a shape that protrudes outward from the first wall portion 360. A contact surface 311 through which the ejector pin may be contacted may be formed on the pushing pin portion 310. The contact surface 311 may be formed on the rear surface of the valve seat 300. The pushing pin portion 310 may be formed in the second area (A2′) of the valve seat 300.

Referring to FIG. 15, a chamfer portion 365 may be formed in a portion in which an outer portion 360a of the first wall portion 360 and an outer portion 330a of the contact portion 330 are connected to each other, based on the horizontal cross-section of the valve seat 300. The chamfer portion 365 refers to a portion in which an edge where two lines or surfaces meet each other at a certain angle is obliquely cut in a straight line. A first round portion 366 with a first curvature may be formed on the rear side of the chamfer portion 365. The first round portion 366 may have the first curvature. The outer portion 360a of the first wall portion 360 may be obliquely formed in the inner direction of the first wall portion 360 from the rear end of the first round portion 366 to one end of the second stopper shaped portion 350-2.

A second round portion 367 may be formed in a portion in which an outer portion 370a of the second wall portion 370 and the outer portion 330a of the contact portion 330 are connected to each other, based on the horizontal cross-section of the valve seat 300. The second round portion 367 may be formed with a second curvature.

The chamfer portion 365 and the first round portion 366 may be formed along the first wall portion 360, and the second round portion 367 may be formed along the second wall portion 370. Meanwhile, an area in which the chamfer portion 365 is formed may be larger than an area in which the second round portion 367 is formed.

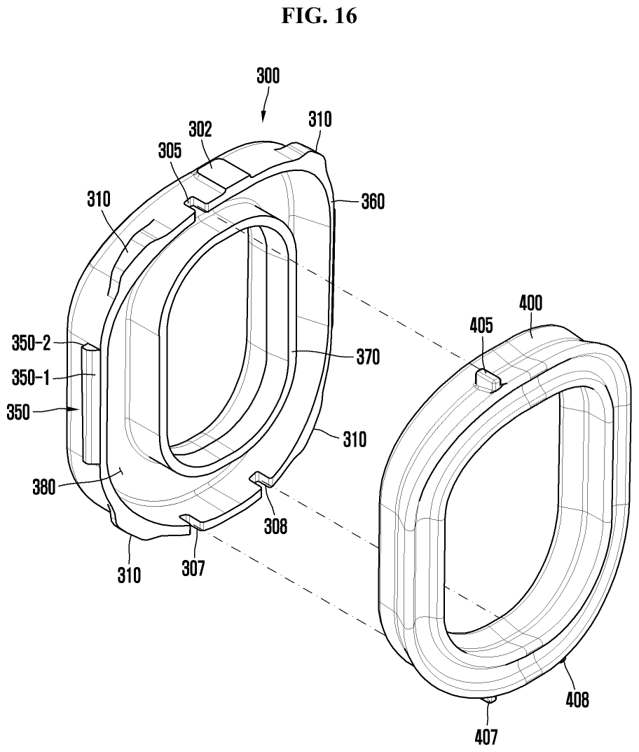

FIG. 16 illustrates a state in which a sealing portion is separated from a valve seat according to another example embodiment.

Referring to FIG. 16, in another example embodiment, a sealing portion 400 may insert into the insertion groove 380 of the valve seat 300. Description related to the sealing portion 400 may refer to the description made above in relation to the sealing portion 40 according to an example embodiment.

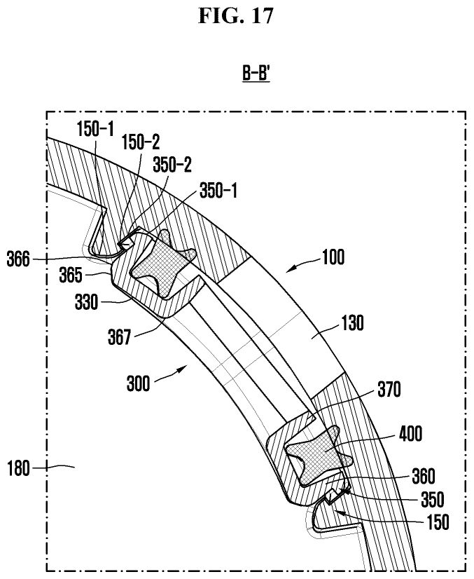

A first protrusion 405 may be formed on the upper side of the sealing portion 400, and second protrusions 407 and 408 may be formed on the lower side thereof. The first protrusion 405 and the second protrusions 407 and 408 may be formed to protrude outward from the sealing portion 400. The first protrusion 405 may have a shape that may insert into the first groove 305 of the valve seat 300, and the second protrusions 407 and 408 may have a shape that may insert into the second grooves 307 and 308 of the valve seat 300. The first protrusion 405 may be formed at a location corresponding to the first groove 305, and the second protrusions 407 and 408 may be formed at locations corresponding to the second grooves 307 and 308, respectively. The number of first protrusions 405 may be equal to the number of first grooves 305, and the number of second protrusions 407 and 408 may be equal to the number of second grooves 307 and 308. FIG. 17 is a view cut along line B-B′ of FIG. 10.

The principle that the second fastening portion 350 of the valve seat 300 fastens to the first fastening portion 150 of the valve housing 100 may refer to the contents described above in an example embodiment. As shown in FIG. 17, referring to a state in which the valve seat 300 is fastened to the valve housing 100, the valve seat 300 may be provided such that one side of the chamfer portion 365 of the valve seat 300 is almost adjacent to the first insertion shaped portion 150-1 of the first fastening portion 150. The rear end of the chamfer portion 365 may be provided to face the curved shape of the first insertion shaped portion 150-1.

Although the present invention is described with reference to specific example embodiments, it is provided as an example only and it will be apparent to one of ordinary skill in the art that various changes and modifications in forms and details may be made in these example embodiments without departing from the technical spirit of the various example embodiments. Therefore, other implementations, other example embodiments, and equivalents of the claims are to be construed as being included in the claims.

What is claimed is:

1. A valve seat assembly structure comprising:
a valve housing including an inner wall and a single pair of first fastening portions having a shape that protrudes from the inner wall and provided to face each other; and
a valve seat provided between the single pair of first fastening portions and including a second fastening portion formed on the side to couple with the first fastening portion,
wherein each of the first fastening portion and the second fastening portion includes an insertion shaped portion having a curved shape and a stopper shaped portion having a planar shape.

2. The valve seat assembly structure of claim 1, wherein the first fastening portion includes:
a (1-1)-th insertion shaped portion that vertically extends in the vertical direction of the valve housing; and
a (1-1)-th stopper shaped portion that is formed in the inner direction of the first fastening portion at the end of the largest horizontal cross-section of the (1-1)-th insertion shaped portion.

3. The valve seat assembly structure of claim 2, wherein the first fastening portion includes:
a (1-2)-th insertion shaped portion that extends in a curved shape from the lower side of the (1-1)-th insertion shaped portion; and
a (1-2)-th stopper shaped portion that extends in the inner direction of the first fastening portion at the end of the largest horizontal cross-section of the (1-2)-th insertion shaped portion.

4. The valve seat assembly structure of claim 1, wherein the second fastening portion includes:
a (2-1)-th insertion shaped portion that is formed in a straight area on the side of the valve seat, and vertically extends in the vertical direction of the valve seat; and
a (2-1)-th stopper shaped portion that is formed in the inner direction of the second fastening portion at the end of the largest horizontal cross-section of the (2-1)-th insertion shaped portion.

5. The valve seat assembly structure of claim 4, wherein the second fastening portion includes:
a (2-2)-th insertion shaped portion that is formed in a curved area on the side of the valve seat and extends in a curved shape from the lower side of the (2-1)-th insertion shaped portion; and
a (2-2)-th stopper shaped portion that extends in the inner direction of the second fastening portion at the end of the largest horizontal cross-section of the (2-1)-th insertion shaped portion.

6. The valve seat assembly structure of claim 1, wherein the valve seat is curved on both left and right sides to have a constant curvature based on a vertical centerline.

7. The valve seat assembly structure of claim 1, wherein the valve seat includes:
a first wall portion formed on its outside; and
a second wall portion formed to surround a center hole of the valve seat, and
an insertion groove is formed between the first wall portion and the second wall portion.

8. The valve seat assembly structure of claim 7, wherein a sealing portion inserts into the insertion groove.

9. The valve seat assembly structure of claim 8, wherein the sealing portion is an X-ring or an O-ring.

10. A valve seat assembly structure comprising:
a valve housing including an inner wall and a single pair of first fastening portions having a shape that protrudes from the inner wall and provided to face each other;
a valve seat formed with an insertion groove, provided between the single pair of first fastening portions, and having a second fastening portion to couple with the first fastening portion; and
a sealing portion configured to insert into the insertion groove,
wherein the valve seat includes a closed portion, a first wall portion formed on the outside based on the insertion groove, and a second wall portion formed on the inner side than the first wall portion,
a chamfer portion obliquely provided to face the first fastening portion is formed in a portion in which an outer portion of the closed portion and an outer portion of the first wall portion are connected to each other, and
a round portion having a first curvature is formed in a portion in which the outer portion of the closed portion and an outer portion of the second wall portion are connected to each other.
